(19) United States
(12) Patent Application Publication
(10) Pub. No.: US 2016/0265986 A1
(43) Pub. Date: Sep. 15, 2016

(54) SENSOR AND SENSOR SYSTEM

(71) Applicant: KABUSHIKI KAISHA TOSHIBA, Tokyo (JP)

(72) Inventors: Daiki ONO, Yokohama Kanagawa (JP); Naofumi NAKAMURA, Tokyo (JP); Yumi HAYASHI, Ayase Kanagawa (JP); Ryunosuke GANDO, Yokohama Kanagawa (JP)

(73) Assignee: KABUSHIKI KAISHA TOSHIBA, Tokyo (JP)

(21) Appl. No.: 14/841,375

(22) Filed: Aug. 31, 2015

(30) Foreign Application Priority Data
Mar. 13, 2015 (JP) 2015-050617

(51) Int. Cl. G01L 1/14

(52) U.S. Cl. CPC G01L 1/14

(57) ABSTRACT

According to one embodiment, a sensor includes a substrate, a first MEMO element provided on the substrate, a cap layer providing a cavity for accommodating the first MEMS element, and a second MEMS element for monitoring a pressure in the cavity, the second MEMS element being provided on the substrate in the cavity.

### CROSS-REFERENCE TO RELATED APPLICATIONS

This application is based upon and claims the benefit of priority from Japanese Patent Application No. 2015-050617, filed Mar. 13, 2015, the entire contents of which are incorporated herein by reference.

### FIELD

Embodiments described herein relate generally to a sensor and a sensor system in which a MEMS element is used.

### BACKGROUND

In a pressure sensor in which a MEMS element is used, a movable electrode and a fixed electrode are disposed in an airtightly sealed thin-film dome. In addition, according to an external pressure change, the dome and the fixed electrode are displaced and the capacitance between the movable electrode and the fixed electrode varies. This variation in capacitance is detected, whereby pressure is measured.

However, in this kind of pressure sensor, the airtightness of a dome is important, and if the pressure in the dome is abnormal, an accurate measurement cannot be taken. Further, if a micro-vacuum gauge including a thermocouple is used to monitor the pressure in the dome, the manufacturing cost is increased.

### BRIEF DESCRIPTION OF THE DRAWINGS

FIG. 1 is a cross-sectional view showing a schematic structure of a MEMS device according to a first embodiment;

FIG. 2 is a plan view showing the schematic structure of the MEMS device according to the first embodiment;

FIG. 3A to FIG. 3F are cross-sectional views showing a manufacturing process of the MEMS device of the first embodiment;

FIG. 4A and FIG. 4B are schematic views showing a relationship between a direct-current voltage applied to a second MEMS element used in the first embodiment and the displacement of a movable electrode;

FIG. 5 is a characteristic view showing oscillation properties of the movable electrode in the second MEMS element used in the first embodiment;

FIG. 6 is an illustration showing an example of a Q-value measurement circuit of the second MEMS element used in the first embodiment;

FIG. 7 is a characteristic view showing a relationship between an applied frequency and the displacement of the movable electrode when a high-frequency voltage is applied to the second MEMS element used in the first embodiment;

FIG. 8 is an illustration showing a schematic structure of a MEMS system according to a second embodiment;

FIG. 9 is a cross-sectional view showing a schematic structure of a MEMS device according to a third embodiment; and

FIG. 10 is a plan view showing the schematic structure of the MEMS device according to the third embodiment.

### DETAILED DESCRIPTION

In general, according to one embodiment, a sensor comprises: a substrate; a first MEMS element provided on the substrate; a cap layer provided on the substrate and the first MEMS element to provide a cavity accommodating the first MEMS element; and a second MEMS element for monitoring a pressure in the cavity, the second MEMS element being provided on the substrate in the cavity.

sensors and sensor systems of embodiments will be described hereinafter with reference to the accompanying drawings.

### First Embodiment

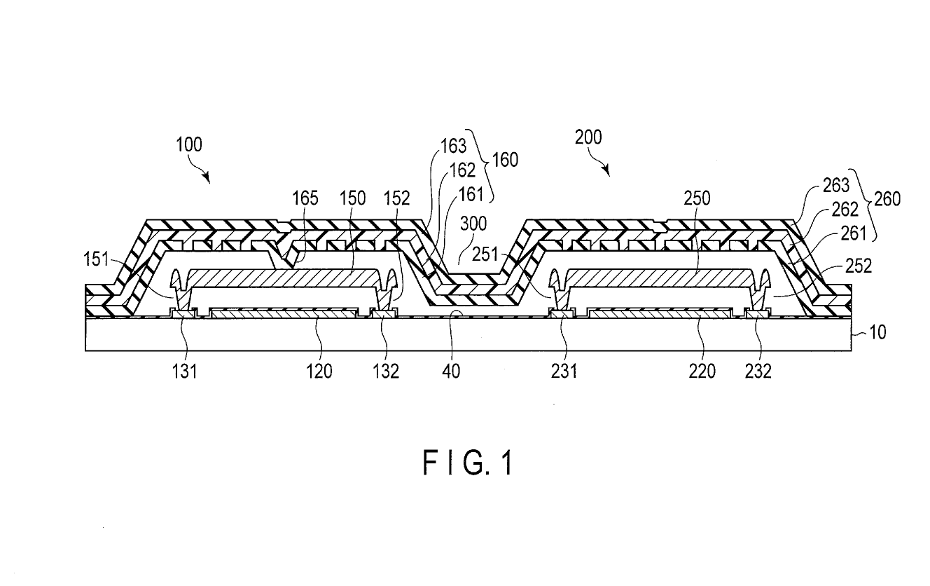

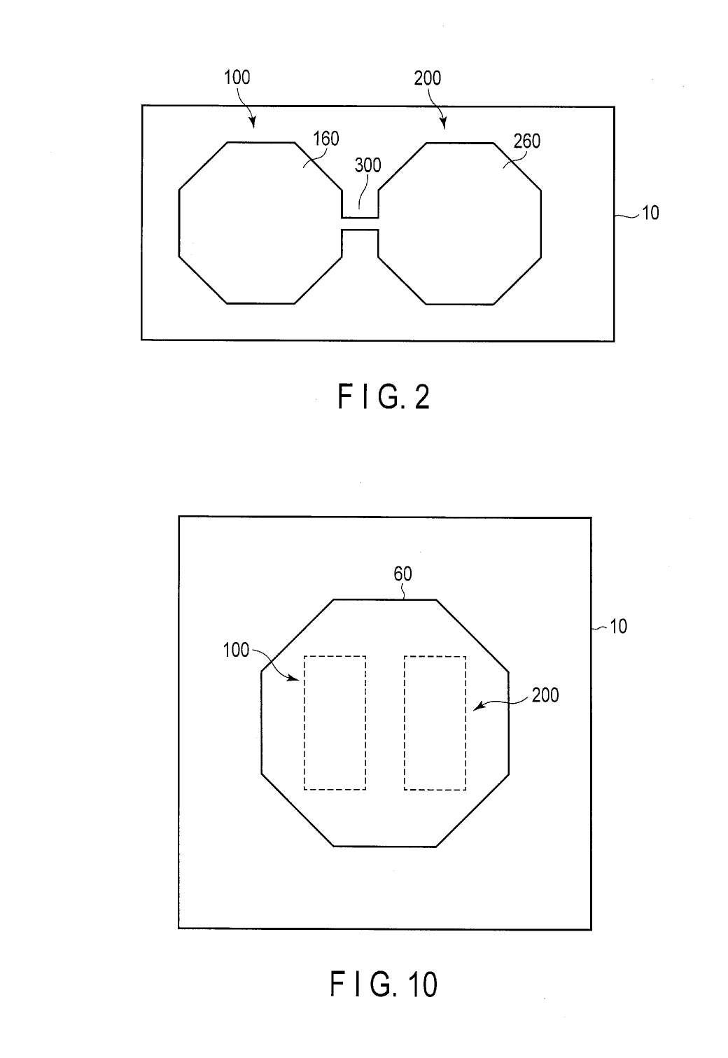

FIG. 1 and FIG. 2 are illustrations for explaining a schematic structure of a MEMS device according to a first embodiment. FIG. 1 is a cross-sectional view, and FIG. 2 is a plan view. The MEMS device is used as a pressure sensor.

On a substrate 10 of Si, etc., a first MEMS element 100 for measuring external pressure and a second MEMS element 200 for monitoring internal pressure are disposed adjacently.

The first MEMS element 100 functions as a main pressure sensor, and has the following structure.

On the substrate 10 of Si, etc., for example, a first fixed electrode (lower electrode) 120 in the shape of a flat plate and first interconnects 131 and 132 are provided. A planar pattern of the fixed electrode 120 is basically a polygon (octagon). The interconnects 131 and 132 are provided outside the fixed electrode 120. Materials for the fixed electrode 120 and the interconnects 131 and 132 are, for example, Al or an alloy of AlCu. The fixed electrode 120 and the interconnects 131 and 132 are covered by an SiN film 40, and openings are provided in the SiN film 40 on the interconnects 131 and 132.

Above the fixed electrode 120, a first movable electrode (upper electrode) 150 in the shape of a flat plate is provided to be movable up and down. A planar pattern of the movable electrode 150 is basically a polygon (octagon) similarly to the fixed electrode 120, and the movable electrode 150 is disposed to face the fixed electrode 120. Ends of the movable electrode 150 are connected to the interconnects 131 and 132 through first springs 151 and 152.

Materials for the movable electrode 150 and the springs 151 and 152 are, for example, Al or an alloy of AlCu. The springs 151 and 152 are integrally formed with the movable electrode 150, and are smaller in thickness than a flat portion of the movable electrode 150. Moreover, positions where the springs are provided are not limited to two facing places of the movable electrode 150, and may be four places shifted by 90 degrees with respect to a center of the movable electrode 150.

A first thin-film dome (thin-film structure) 160 having a layered structure is provided on the substrate 10 to form a first cavity for accommodating the fixed electrode 120, the interconnects 131 and 132, and the movable electrode 150. In addition, this thin-film dome 160 is sealed in a vacuum. The thin-film dome 160 has a layered structure of, for example, a first insulating film 161 of SiO, SiN, etc., an organic resin film 162 of polyimide, etc., and a second insulating film 163 of SiO, SiN, etc.

An anchor 165 is provided at a central portion inside the thin-film dome 160. The movable electrode 150 is jointed to the central portion inside the thin-film dome 160 through the anchor 165. The movable electrode 150 thereby can move up and down with the thin-film dome 160.

The second MEMS element 200 comprises a second fixed electrode 220, second interconnects 231 and 232, a second movable electrode 250, and a second thin-film dome (thin-film structure) 260 similarly to the first MEMS element 100, and a basic structure thereof is the same as that of the first MEMS element 100. The second MEMS element 200 differs from the first MEMS element 100 in that no portion corresponding to the anchor 165 is provided and the second movable electrode 250 and the second thin-film dome 260 for forming a second cavity are not connected.

In addition, parts of the first thin-film dome 160 and the second thin-film dome 260 are connected through a connection 300. The first cavity of the first thin-film dome 160 and the second cavity of the second thin-film dome 260 thereby communicate with each other.

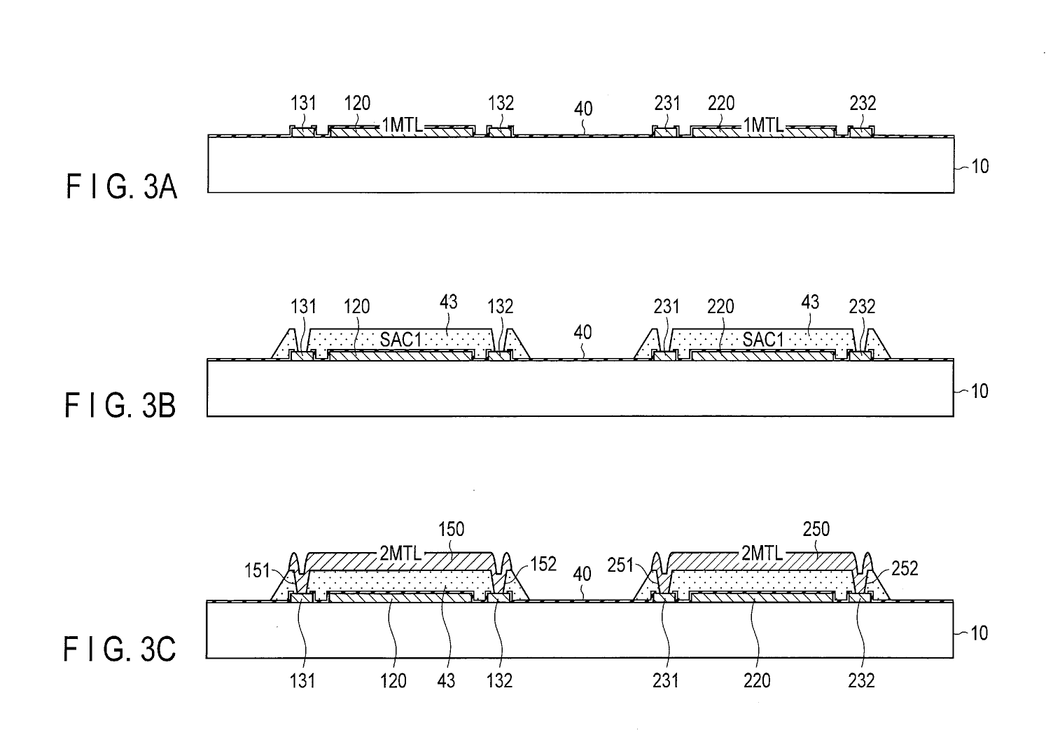

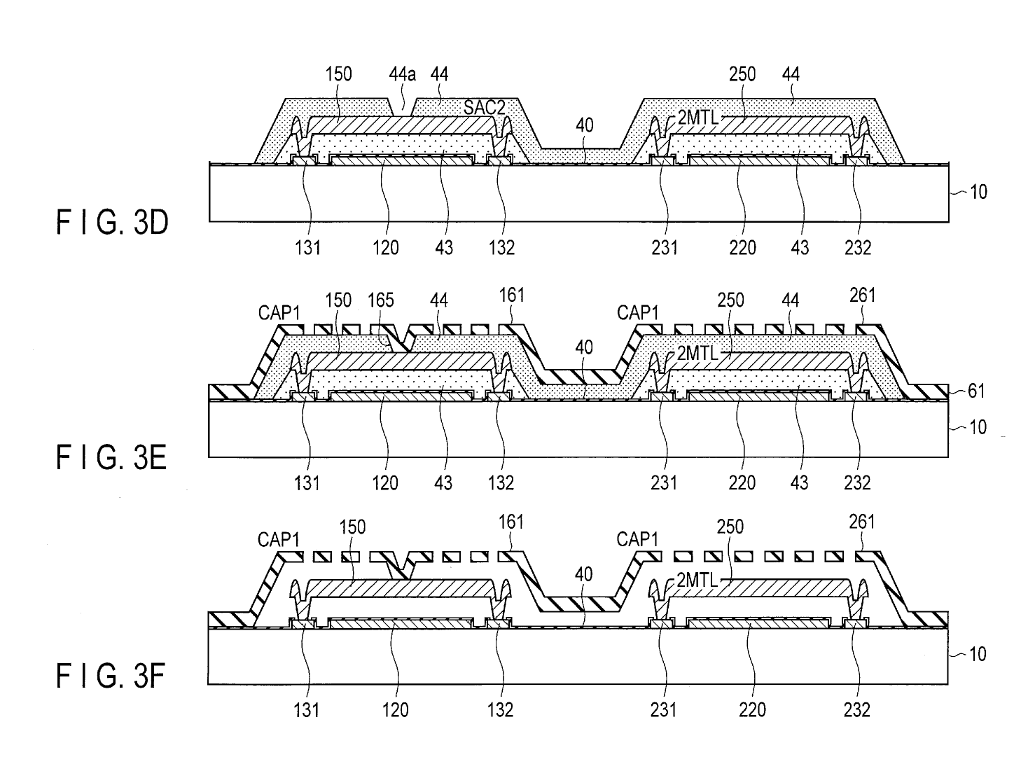

Next, a method for manufacturing the MEMS device of the present embodiment will be described with reference to FIG. 3A to FIG. 3F.

First, as shown in FIG. 3A, fixed electrodes (1MTL) are formed on the substrate of Si, etc. For example, after an Al film is formed on the whole area of the substrate 10 by Al sputtering, the first fixed electrode 120 and the first interconnects 131 and 132 are formed in a first MEMS element area by lithography and RIE. At the same time, the second fixed electrode 220 and the second interconnects 231 and 232 are formed in a second MEMS element area. Next, after the SiN film 40 is deposited by a plasma CVD method, etc., openings are formed at desired portions by using, for example, lithography and RIE.

Next, as shown in FIG. 3B, first sacrificial layers 43 (SAC1) are formed in the first and second MEMS element areas to cover the fixed electrodes 120 and 220 and the interconnects 131, 132, 231 and 232. A coating film of an organic resin having C as a main component, for example, polyimide, is used as the sacrificial layers 43. The thickness of the sacrificial layers 43 is, for example, several hundred nanometers to several micrometers. Then, the sacrificial layers 43 are patterned into a desired shape. Parts of the interconnects 131 and 132, 231 and 232 are thereby exposed.

Next, as shown in FIG. 3C, movable electrodes (2MTL) are formed. For example, after an Al film is formed on the whole area by Al sputtering, the Al film is left in the first and second MEMS element areas by lithography and wet etching. Thus, the first movable electrode 150 is formed in the first MEMS element area and the second movable electrode 250 is formed in the second MEMS element area.

Here, the Al film is formed to be small in thickness between the flat portion of the movable electrode 150 and the interconnects 131 and 132, and these portions function as the springs 151 and 152. Similarly, the Al film is formed to be small in thickness between a flat portion of the movable electrode 250 and the interconnects 231 and 232, and these portions function as springs 251 and 252.

Next, as shown in FIG. 3D, a second sacrificial layer 44 (SAC2) is formed. A material for this sacrificial layer 44 is the same as that of the first sacrificial layers 43. Then, the sacrificial layer 44 outside the first and second MEMS element areas is removed. At this time, the sacrificial layer 44 is left to connect a part of the first MEMS element area and a part of the second MEMS element area. In addition, in the first MEMS element area, the sacrificial layer 44 is patterned to have an opening reaching the movable electrode 150. That is, an opening 44a is formed at a portion where the anchor is formed.

Next, as shown in FIG. 3E, an SiO film 61 (CAP1) having a thickness of one hundred nanometers to several micrometers is deposited by a CVD method, etc., openings are formed at desired portions by using lithography and RIE. Here, the SiO film on the first MEMS element area side is defined as 161, and the SiO film on the second MEMS element area side is defined as 261. A part of the SiO film 161 forms the anchor 165, and the anchor 165 contacts a top surface of the movable electrode 150 in the first MEMS element area.

In addition, when patterning the SiO film 61, it is desirable to make the shape of an opening gradually smaller in diameter from outside to inside by adjusting a selection ratio between a resist pattern not shown in the figure and the SiO film 61. In other words, it is desirable that the shape of an opening be a tapering shape which becomes gradually smaller in diameter from outside to inside. This is for the purpose of improving the sealing properties of the opening after the first and second sacrificial layers 43 and 44 are removed in a post-process.

Next, as shown in FIG. 3F, the first and second sacrificial layers 43 and 44 are removed by, for example, O₂ asking through the openings of the SiO films 161 and 261. As a result, a cavity as a space for movable portions of the MEMS elements to move can be obtained.

Thereafter, polyimide films 162 and 262 (PI) are formed on the SiO films 161 and 261, whereby the openings of the SiO films 161 and 261 are closed by the polyimide films 162 and 262. Moreover, SiN films 163 and 263 having a thickness of one hundred nanometers to several micrometers are deposited by a CVD method, etc., whereby the structure shown in FIG. 1 is completed.

Next, the functions of the first and second MEMS elements 100 and 200 will be explained.

The first MEMS element 100 is the same as a normal MEMS element used as a pressure sensor. That is, the movable electrode 150 is pressed to a lower side by the differential pressure between a vacuum in an internal cavity and external pressure. In addition, the distance between the movable electrode 150 and the fixed electrode 120 varies according to the external pressure. Thus, the external pressure can be measured by measuring the capacitance between the movable electrode 150 and the fixed electrode 120.

The principle of monitoring pressure by the second MEMS element 200 is as described below.

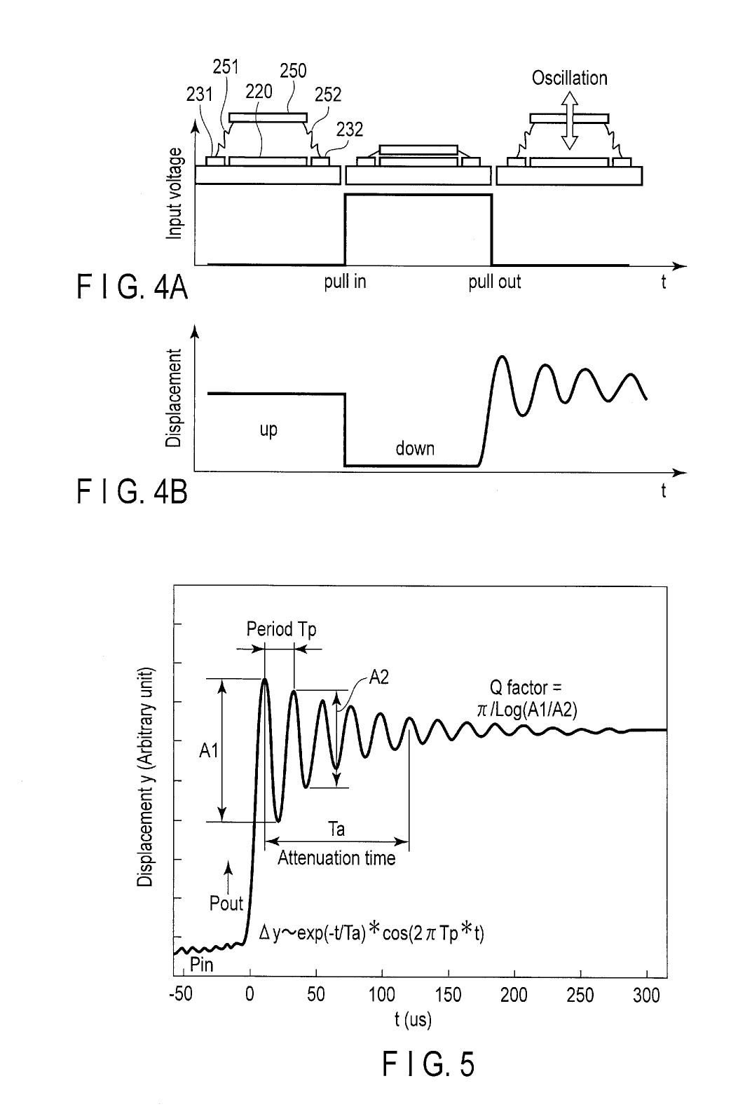

FIG. 4A shows an input voltage of the movable electrode 250, and FIG. 4B shows the displacement of the movable electrode 250. If a direct-current voltage is not applied between the fixed electrode 220 and the movable electrode 250, the movable electrode 250 is separated from the fixed electrode 220 (up state). If a direct-current voltage is applied (pulled in) between the fixed electrode 220 and the movable electrode 250, the movable electrode 250 is drawn to the fixed electrode 220 side, and contacts the fixed electrode 220 side (down state). If the application of a voltage is stopped (pulled out) from this state, the movable electrode 250 is separated from the fixed electrode 220 side.

At this time, since the movable electrode 250 is connected to the interconnects 231 and 232 through the springs 251 and 252, the movable electrode 250 oscillates for a certain time. This oscillation time varies according to the pressure around the movable electrode 250, that is, the pressure around the sensor. That is, the air pressure acts as resistance, and as the air pressure is smaller, oscillation (Q value) becomes larger. Accordingly, the pressure around the sensor can be measured by measuring the above oscillation properties (see, for example, Sensor and Actuators A48 (1995) 239-248, “Equivalent-circuit model of the squeezed gas film in a silicon accelerometer”).

FIG. 5 is an illustration showing the oscillation properties of the movable electrode 250 in more detail. If we denote a first peak of oscillation as Al, and a peak which comes after one time period Tp from the first peak as A2, a Q value is computed as Q=π/log(A1/A2). This variation of the Q value is large especially in a low-pressure area of 0.1 to 10 kPa, and is thus effective in measurement in a vacuum or a low-pressure area.

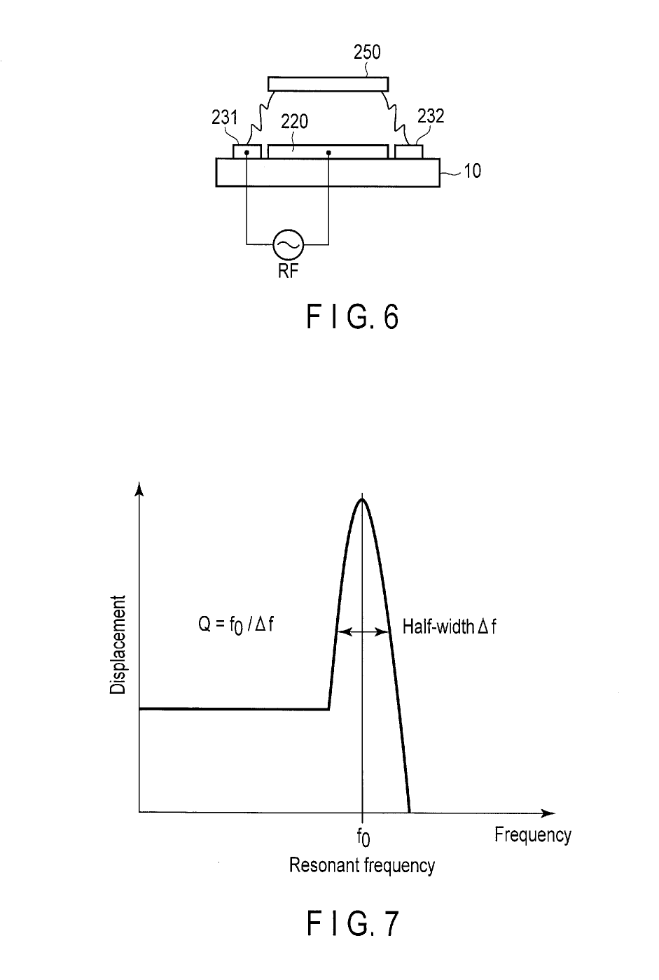

In addition, for example, as shown in FIG. 6, a high-frequency voltage close to a resonant frequency is applied between the fixed electrode 220 and the movable electrode 250. When the high-frequency voltage is applied, the displacement of the movable electrode 250 reaches a peak at a certain resonant frequency as shown in FIG. 7. Further, this peak value varies according to the pressure around the movable electrode 250. That is, the sharpness (Q value) of the peak decreases according to an increase in air pressure. Accordingly, the pressure can be measured by measuring a peak value.

More specifically, if we denote a resonant frequency as f0 and a half-width as Δf, Q is computed as Q=f0/Δf.

In this manner, the pressure in a thin-film dome 60 (160 and 260) can be measured by the second MEMS element 200. That is, the airtightness of the thin-film dome 60 can be measured.

Therefore, according to the present embodiment, the second MEMS element 200 for monitoring internal air pressure can be mounted in the same cavity as the main first MEMS element 100, and corrections can be made according to fault determination and an internal air pressure change.

That is, in measuring the external pressure by the first MEMS element 100, a measurement error can be prevented in advance by monitoring the airtightness of the thin-film dome 60 by the second MEMS element 200. The reliability in measurement can be thereby improved. Moreover, a detected output of the first MEMS element 100 is corrected based on a detected output of the second MEMS element 200, whereby an accurate measurement can be taken even if a slight leakage due to change over time, etc., occurs in the thin-film dome 60.

Furthermore, in this case, the second MEMS element 200 for monitoring can be simultaneously manufactured in the same process as that of the main first MEMS element 100. Thus, this case can be implemented without changing a manufacturing process as compared to the case of monitoring internal pressure using a thermocouple. Accordingly, a manufacturing cost can be more reduced than in the case where a thermocouple type is adopted. That is, the pressure in the domes can be monitored without using a special element such as a thermocouple, and reliability can be improved.

In addition, since the connection 300 for connecting the two thin-film domes 160 and 260 is made as thin as possible, the movement of the movable electrode 150 is hardly influenced by connecting the domes 160 and 260. That is, there is also an advantage that the pressure in the dome can be monitored with little influence on the measurement by the first MEMS element 100.

### Second Embodiment

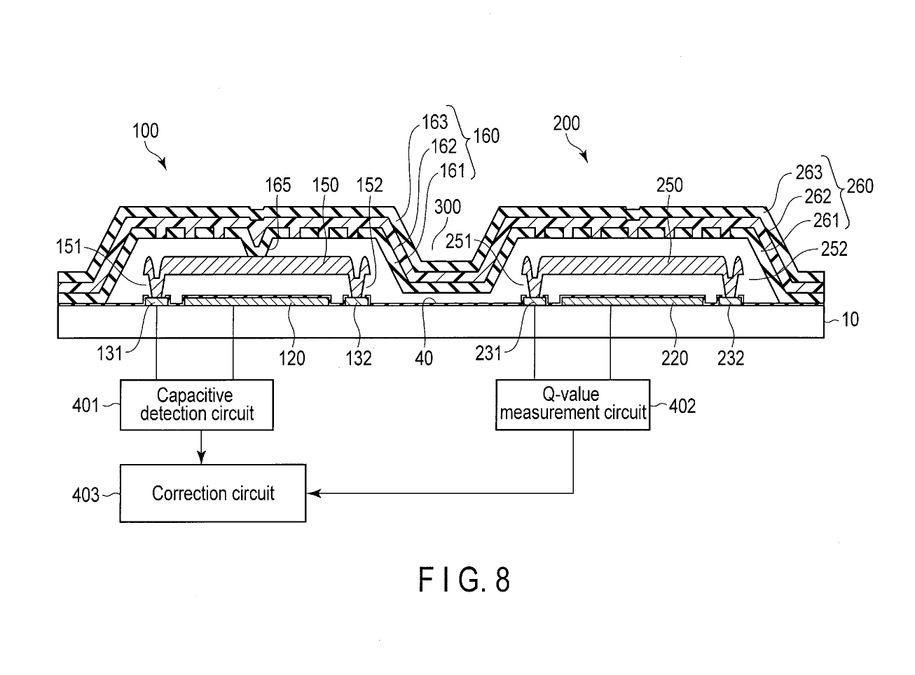

FIG. 8 is an illustration showing a schematic structure of a MEMS system according to a second embodiment. It should be noted that the same portions as those of FIG. 1 are given the same numbers as those of FIG. 1, and detailed explanations thereof will be omitted.

In the present embodiment, in addition to the above-described first embodiment, a capacitive detection circuit (MEMS movement detection circuit) 401 which detects the capacitance between electrodes of a first MEMS element 100, a Q-value measurement circuit (cavity internal pressure detection circuit) 402 for measuring a Q value of a second MEMS element 200, and further a correction circuit (signal processing circuit) 403 which corrects an output of the capacitive detection circuit 401 based on an output signal of the Q-value measurement circuit 402 are provided.

The capacitive detection circuit 401 detects the capacitance between electrodes 120 and 150 of the first MEMS element 100. Because this capacitance varies according to an external pressure change, the capacitive detection circuit 401 detects external pressure.

The Q-value measurement circuit 402 measures a Q value based on such oscillation properties as shown in FIG. 5 which can be obtained when a voltage as shown in FIG. 4B is applied. Since a Q value varies according to the pressure in a cavity, the Q-value measurement circuit 402 measures the pressure in the cavity.

The correction circuit 403 determines the external pressure from an output signal of the capacitive detection circuit 401, if the pressure in the cavity is normal (vacuum), for example, from an output signal of the Q-value measurement circuit 402. If the pressure in the cavity is abnormal from an output signal of the Q-value measurement circuit 402, the measurement of the external pressure based on an output signal of the capacitive detection circuit 401 is halted.

In addition, if a change in the pressure in the cavity is minute, for example, if the degree of a vacuum in the cavity is slightly decreased because of change over time, a measurement error due to the change in the pressure in the cavity can also be reduced by correcting an output signal of the capacitive detection circuit 401 based on an output signal of the Q-value measurement circuit 402.

In this manner, according to the present embodiment, external pressure can be measured while the pressure in a dome is monitored, by providing the capacitive detection circuit 401, the Q-value measurement circuit 402, and the correction circuit 403 in addition to the first and second MEMS elements 100 and 200 described in the first embodiment. Therefore, the reliability of pressure measurement by the first MEMS element 100 can be improved.

It should be noted that each of the circuits 401 to 403 may be provided on a substrate other than a substrate 10 as an external circuit, but may also be provided on the substrate 10 as a CMOS hybrid circuit. If the circuits 401 to 403 are provided on the substrate 10, the following advantage can also be obtained; that is, an interconnect for connecting an MEMS element and a circuit becomes the shortest and a parasitic capacitance can be made as small as possible. This leads to an improvement of sensitivity in measuring pressure. Moreover, since the CMOS hybrid circuit is provided on an underlying substrate of the MEMS element, the MEMS device can be formed in a wafer-level package structure, and can be miniaturized.

### Third Embodiment

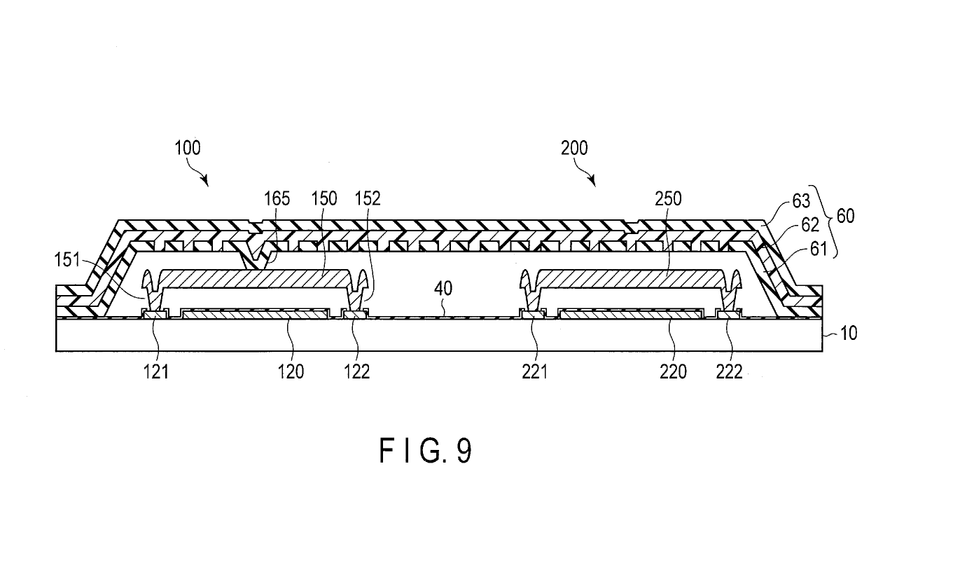

FIG. 9 and FIG. 10 are illustrations for explaining a MEMS device according to a third embodiment. FIG. 9 is a cross-sectional view, and FIG. 10 is a plan view. It should be noted that the same portions as those of FIG. 1 and FIG. 2 are given the same numbers as those of FIG. 1 and FIG. 2, and detailed explanations thereof will be omitted.

The present embodiment differs from the above-described first embodiment in that first and second MEMS elements 100 and 200 are not provided in separate thin-film domes, but are provided in the same thin-film dome. That is, the first MEMS element 100 and the second MEMS element 200 are accommodated in a single thin-film dome 60 comprising a first insulating film 61, an organic resin film 62, and a second insulating film 63.

Even in such a structure, as in the above-described first embodiment, external pressure can be measured by the first MEMS element 100, and the pressure in a cavity can be monitored by the second MEMS element 200. Thus, the same advantages as those of the first embodiment can be obtained. In addition, the thin-film dome 60 is single, and a structural portion other than the dome, such as the connection 300, need not be provided. Thus, there is also an advantage that a manufacturing process can be simplified.

(Modification)

It should be noted that the present invention is not limited to each of the above-described embodiments.

A first MEMS element is not necessarily limited to a pressure sensor, and can be applied to those comprising a mechanically movable portion and accommodated in a domed thin-film structure. For example, the first MEMS element can be applied to an acceleration sensor, a gyroscopic sensor, and further an oscillator, as well as a pressure sensor. Moreover, the structure of a second MEMS element is not limited to those comprising a fixed electrode and a movable electrode, and may be any structure which can monitor the pressure in a dome.

A MEMS movement detection circuit connected to the first MEMS element is not necessarily limited to those detecting capacitance. Because a mechanically movable portion of the first MEMS element is displaced or deformed because of pressure or other external factors, a circuit which can detect the displacement or the deformation of the mechanically movable portion (movable electrode 150) may be provided instead of the capacitive detection circuit of the second embodiment.

In addition, although a movable electrode and springs are integrally formed in the embodiments, the movable electrode and the springs may be formed of electrically conductive films of different materials. For example, an anchor may be fixed on an interconnect to connect one end of a spring separated from a movable electrode to one end of the movable electrode and connect the other end of the spring to the anchor. Furthermore, the movable electrode is note limited to Al or an alloy of AlCu, and various electrically conductive materials can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor comprising:
a substrate;
a first MEMS element provided on the substrate;
a cap layer provided on the substrate and the first MEMS element to provide a cavity accommodating the first MEMS element; and
a second MEMS element for monitoring a pressure in the cavity, the second MEMS element being provided on the substrate in the cavity.

2. The device of claim 1, wherein the second MEMS element comprises a fixed electrode for the second MEMS element fixed on the substrate, and a movable electrode for the second MEMS element disposed above the fixed electrode to be movable up and down, and
the pressure in the cavity is measured based on a mechanical oscillation property of the movable electrode.

3. The device of claim 2, wherein a temporal change in oscillation of the movable electrode which is made when the movable electrode is driven by a direct-current voltage is measured in the second MEMS element.

4. The device of claim 2, wherein a change in displacement of the movable electrode which is made when a high-frequency voltage is applied to the movable electrode is measured in the second MEMS element.

5. The device of claim 1, wherein the cap layer comprises a first thin-film structure of a dome shape providing a first cavity for accommodating the first MEMS element with the substrate, a second thin-film structure of a dome shape providing a second cavity for accommodating the second MEMS element with the substrate, and a connection connecting the first and second cavities spatially.

6. The device of claim 1, wherein the cap layer comprises a first insulating film comprising openings, a resin film provided on the first insulating film to cover the openings, and a second insulating film provided on the resin film.

7. The device of claim 1, wherein the first MEMS element comprises a fixed electrode for the first MEMS element fixed on the substrate, and a movable electrode for the first MEMS element disposed above the fixed electrode to be movable up and down, and
a capacitance between the fixed electrode and the movable electrode is measured.

8. A sensor system comprising:
a substrate;
a first MEMS element provided on the substrate, the first MEMS element comprising a mechanically movable portion;
a cap layer provided on the substrate and the first MEMS element to provide a cavity accommodating the first MEMS element;
a second MEMS element accommodated in the cavity for monitoring a pressure in the cavity, the second MEMS element comprising a fixed electrode for the second MEMS element fixed on the substrate and a movable electrode for the second MEMS element disposed above the fixed electrode to be movable up and down;
a MEMS movement detection circuit configured to detect displacement or deformation of the mechanically movable portion of the first MEMS element, the MEMS movement detection circuit being connected to the first MEMS element;
a cavity internal pressure detection circuit configured to detect the pressure in the cavity based on a mechanical oscillation property of the movable electrode, the cavity internal pressure detection circuit being connected to the second MEMS element; and
a signal processing circuit configured to process an output signal of the MEMS movement detection circuit based on an output signal of the cavity internal pressure detection circuit.

9. The system of claim 8, wherein a temporal change in oscillation of the movable electrode which is made when the movable electrode is driven by a direct-current voltage is measured in the second MEMS element.

10. The system of claim 8, wherein a change in displacement of the movable electrode which is made when a high-frequency voltage is applied to the movable electrode is measured in the second MEMS element.

11. The system of claim 8, wherein the cap layer comprises a first thin-film structure of a dome shape providing a first cavity for accommodating the first MEMS element with the substrate, a second thin-film structure of a dome shape providing a second cavity for accommodating the second MEMS element with the substrate, and a connection connecting the first and second cavities spatially.

12. The system of claim 8, wherein the cap layer comprises a first insulating film comprising openings, a resin film provided on the first insulating film to cover the openings, and a second insulating film provided on the resin film.

13. The system of claim 8, wherein the first MEMS element comprises a fixed electrode for the first MEMS element fixed on the substrate, and a movable electrode for the first MEMS element disposed above the fixed electrode to be movable up and down, and
a capacitance between the fixed electrode for the first MEMS element and the movable electrode for the first MEMS element is measured in the MEMS movement detection circuit.

14. A sensor comprising:
a substrate;
a first MEMS element provided on the substrate, the first MEMS element comprising a first fixed electrode fixed on the substrate and a first movable electrode disposed above the first fixed electrode to be movable up and down;
a first thin-film structure of a dome shape provided on the substrate and the first MEMS element to provide a first cavity accommodating the first fixed electrode and the first movable electrode;
a second MEMS element for monitoring a pressure in the cavity, the second MEMS element comprising a second fixed electrode fixed on the substrate and a second movable electrode disposed above the second fixed electrode to be movable up and down;
a second thin-film structure of a dome shape provided on the substrate and the second MEMS element to provide a second cavity accommodating the second fixed electrode and the second movable electrode; and
a connection provided between the first thin-film structure and the second thin-film structure, the connection connecting the first and second cavities spatially,
wherein a capacitance between the first fixed electrode and the first movable electrode is measured in the first MEMS element, and
a pressure in the first and second cavities is measured based on a mechanical oscillation property of the second movable electrode in the second MEMS element.

15. The device of claim 14, wherein a temporal change in oscillation of the second movable electrode which is made when the second movable electrode is driven by a direct-current voltage is measured in the second MEMS element.

16. The device of claim 14, wherein a change in displacement of the second movable electrode which is made when a high-frequency voltage is applied to the second movable electrode is measured in the second MEMS element.

17. The device of claim 14, wherein the first and second thin-film structures each comprise a first insulating film comprising openings, a resin film provided on the first insulating film to cover the openings, and a second insulating film provided on the resin film.
